(19) United States
(12) Patent Application Publication
(10) Pub. No.: US 2022/0347906 A1
(43) Pub. Date: Nov. 3, 2022

(54) METHOD FOR MONITORING THE HYDRAULIC SUPPLY SYSTEM OF A PLASTIC PROCESSING MACHINE

(71) Applicant: Wittmann Battenfeld GmbH, Kottingbrunn (AT)

(72) Inventors: Willibald WARTA, Enzesfeld (AT); Bernhard ZOEHLING, Steinabrueckl (AT)

(21) Appl. No.: 17/730,457

(22) Filed: Apr. 27, 2022

(30) Foreign Application Priority Data
Apr. 29, 2021 (DE) 10 2021 111 083.1

(51) Int. Cl. B29C 45/82; F15B 19/00

(52) U.S. Cl. CPC B29C 45/82; F15B 19/00; B29C 2945/76056; B29C 2945/76214; B29C 2945/76545; B29C 2945/76692

(57) ABSTRACT

A method for monitoring the hydraulic supply system of a plastic processing machine. In order to monitor the state of the hydraulic system without great effort, the method includes the following steps: a) Prior to operation of the machine: Determination of the nominal flow rate of a hydraulic pump as a function of an operating parameter of the hydraulic pump and determination of the nominal displacement speed of the hydraulically driven axis when a piston-cylinder element is acted upon by a predetermined nominal flow rate; b) During operation of the machine: When the hydraulically driven axis is operated: measuring the at least one operating parameter of the hydraulic pump as well as the actual displacement speed of the hydraulic axis and comparing the actual displacement speed with the nominal displacement speed resulting from the previously measured operating parameter of the hydraulic pump, and outputting the result of the comparison.

### CROSS-REFERENCE TO RELATED APPLICATIONS

The present application claims priority of DE 10 2021 111 083.1, filed Apr. 29, 2021, the priority of this application is hereby claimed, and this application is incorporated herein by reference.

### BACKGROUND OF THE INVENTION

The invention relates to a method for monitoring the hydraulic supply system of an at least partially hydraulically operating plastic processing machine, in particular an injection molding machine, wherein the machine has at least one hydraulically driven axis with at least one piston-cylinder element, wherein the hydraulic supply system comprises at least one driven hydraulic pump with which hydraulic oil is delivered and fed into the at least one piston-cylinder element in order to carry out a movement of the axis.

Particularly in hydraulically driven injection molding machines (in contrast to electrically driven injection molding machines the required movements of the machine are accomplished by hydraulic piston-cylinder systems), the swivel angle or the speed of the hydraulic pump is used for control purposes. These parameters are direct factors for the pump delivery rate. Therefore, in the operation of injection molding machines, the above-mentioned parameters of swivel angle and speed are mostly used as determining elements for the piston speeds of the piston-cylinder systems, i.e. the speed of the movement of the corresponding hydraulic axis results from the specification of the swivel angle and/or the speed of the hydraulic pump.

A hydraulically operated injection molding machine is known from DE 39 19 823 A1. This machine is equipped with a control system for feedback-controlling predefined variables, such as the position, speed or force of the components used. The solution described there aims to manage the feedback-control of the drives of the machine with compact elements in order to move the relevant assemblies quickly and with low energy consumption. DE 20 2011 002 591 Ul discloses a hydraulic drive unit with which optimum efficiency is to be achieved in the operation of the drive elements, whereby required stroke volumes of hydraulic fluid can be delivered with the lowest possible energy input from the motor and pump of the system.

What was said at the beginning is also the case here if the drives of the machine are not completely hydraulic, but only partially hydraulic. In this respect, machines are also relevant here which are partially electrically driven but also have at least one hydraulically driven axis (these can be used for partial movements, for example for the ejector and the nozzle system).

The problem here is that aging of the hydraulic pump or the piston seals can lead to a reduction in speed and thus power of the hydraulically driven axis. In this case, the actual process parameters (i.e. in particular the displacement speeds of the hydraulic axes) are adversely affected during operation of the hydraulic pump by nominal values for the swivel angle or for the speed.

### SUMMARY OF THE INVENTION

The invention is based on the object of further developing a method of the type described above in such a way that it is possible to monitor the condition of the hydraulic system without great effort and to determine promptly with the onset of aging processes of the hydraulic system that maintenance of the same is required.

The solution of this problem by the invention is characterized in that that, in order to monitor the aging process or an internal leakage of the hydraulic pump or a hydraulic component of the hydraulic system, it comprises the following steps:
a) Prior operating the plastic processing machine:
a1) determination of the nominal flow rate of the hydraulic pump as a function of at least one operating parameter of the hydraulic pump and
a2) determination of the nominal displacement speed of the hydraulically driven axis when the piston-cylinder element is operated with a predetermined nominal flow rate;
b) During the operation of the plastic processing machine:
b1) When the hydraulically driven axis is operated: Measurement of the at least one operating parameter of the hydraulic pump as well as the actual displacement speed of the hydraulic axis;
b2) Comparison of the actual displacement speed (or a variable directly related thereto) with the nominal displacement speed (or a variable directly related thereto), which result with the at least one operating parameter of the hydraulic pump measured according to step b1), and storage and/or output and/or display of the result of the comparison,
wherein an indication is output if the comparison according to step b2) shows that a deviation between the actual flow rate and the nominal flow rate or between the actual displacement velocity and the nominal displacement velocity has been determined which exceeds a predetermined tolerance.

In particular, said step b2) may comprise the substeps:
b2a) Determination of the actual flow rate required for the measured actual displacement speed;
b2b) Comparing the required actual flow rate with the nominal flow rate resulting from the at least one operating parameter of the hydraulic pump measured according to step b1), and storage and/or output and/or display of the result of the comparison.

The method can be carried out for a number of partial steps of the movement of the hydraulically driven axis. The results of the individual partial steps can then be added up or averaged to arrive at the total movement of the hydraulic axis.

The operating parameter of the hydraulic pump is preferably the rotational speed of the same and/or the swivel angle of the hydraulic pump.

It is particularly preferred that the method is carried out for several hydraulically driven axes. In this case, it is particularly intended that the process is carried out for at least two of the following hydraulically driven axes: Axis for closing a mold, axis for performing an injection process of plastic melt into a mold, axis for moving an injection nozzle for plastic melt, axis for moving an ejector for a manufactured molded part.

It has proved particularly useful if the output of the result of the comparison according to step b2) above is carried out separately for several hydraulically driven axes. In this case, the functionality or efficiency can be checked in a simple manner for several parts of the entire hydraulic system.

Accordingly, a method for determining the condition of the machine's hydraulic system is provided herein.

The proposed concept aims to detect the aging or an internal leakage of the pump or a hydraulic component in a simple way. The relevant operating parameters (namely swivel angle and/or rotational speed) of the hydraulic pump, which determine the volumetric flow of the pump, are detected or recorded during each movement of a hydraulic axis and set in relation to the actual (measured) displacement speed of the hydraulic axis. To this extent, a kind of degree of efficiency of the movement of the hydraulic axis is determined during the movement of the axis.

The main movements of an injection molding machine essentially consist of the opening and closing of the injection mold, the ejector movement, the nozzle movement and the injection process.

If, for example, the degree of efficiency for the closing movement remains constant, but the degree of efficiency for the movement of the hydraulic axis for the injection process changes, an internal or external leakage of the piston-cylinder system for the injection axis can be concluded.

However, if the degree of efficiency changes for both movements (i.e. for the closing movement and the injection process), it can be concluded that a fault has occurred in the pump system.

With the proposed determination and observation of the degree of efficiency of various hydraulic axes of the machine, which is preferably carried out by appropriate software, various defects of the hydraulic system can be detected at an early stage, so that timely machine service can be initiated. Longer production downtimes of the plant are thus prevented. Troubleshooting is made easier for the service team by displaying the respective efficiency levels of the individual hydraulic axes.

For general technology concerning the delivery rate of a hydraulic pump as a function of its drive speed as well as the swivel angle, explicit reference is made to DE 10 2013 005 774 A1.

Further advantages and particulars of the present invention arise out of the exemplary embodiment described in the following and also from the associated drawings.

### BRIEF DESCRIPTION OF THE DRAWING

In the drawing:

FIG. 1 shows schematically an injection molding machine with four hydraulic axes,

FIG. 2 shows an example for determining the degree of efficiency for a closing movement of the hydraulic axis, and

FIG. 3 shows an example for determining the degree of efficiency for an injection movement of the hydraulic axis.

### DETAILED DESCRIPTION OF THE INVENTION

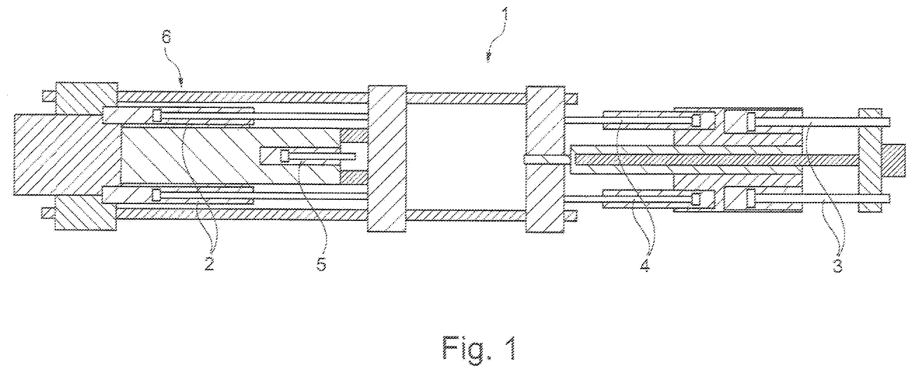

FIG. 1 shows schematically an injection molding machine 1 which is operated hydraulically, whereby an axis 2 is provided by means of the hydraulics for the closing movement of the mold, an axis 3 for the injection movement, an axis 4 for the nozzle movement and an axis 5 for the ejector movement. Each of the axes mentioned comprises a piston-cylinder element, which is indicated by the reference sign 6 as a representative of the hydraulic axis 2.

Not shown is a hydraulic system comprising a hydraulic pump and corresponding hydraulic conduits and control or regulating elements used to cause the flow of hydraulic oil in the system.

In general, the hydraulic pump is operated at a rotational speed n and at a swivel angle α, with the two variables mentioned defining the volume flow rate Q of the hydraulic pump. The flow rate Q of the hydraulic pump is therefore determined by the speed n and/or by the swivel angle α of the hydraulic pump.

The proposed concept is based on the knowledge that the flow rate of hydraulic oil, i.e. specifically the flow rate Q (in liters/min), of the hydraulic pump supplying a hydraulic axis 2, 3, 4, 5 of the machine 1 is always in direct proportion to the displacement speed v of the axis in (mm/s).

If a nominal flow rate Q₀ is assumed, which results from a measurement before bringing into service of the machine, a nominal displacement speed v₀ of the corresponding hydraulic axis 2, 3, 4, 5 of the machine results from this.

If the actual displacement speed v_{Ist} of the hydraulic axis 2, 3, 4, 5 is measured during operation of the machine, a degree of efficiency η of the hydraulic axis can be determined. This is the ratio of two quotients:

η=Quₙₒₘ/Qu_{Ist}

with

Quₙₒₘ=v₀/Q₀

as the ratio of the quotient of the nominal displacement velocity v₀ to the nominal flow rate Q₀ (i.e. in the unit [mm/s per liter/min])
and

Qu_{Ist}=v_{Ist}/Q_{Ist}

as the ratio of the quotient of the actual displacement velocity v_{Ist} to the actual flow rate Q_{Ist} (i.e. in the unit [mm/s per liter/min]). The actual flow rate Q_{Ist} is given by the measured operating parameters of the hydraulic pump, i.e. the swivel angle α and/or the speed n of the pump. The actual flow rate Q_{Ist} is thus inferred or calculated from the measured actual values for the speed and the swivel angle. The correlation between volume flow rate and speed/swivel angle results from the initial determination or measurement of the pump.

By measuring the actual speeds of the hydraulic axes on one side and simultaneously measuring the operating parameters of the hydraulic pump (swivel angle and/or speed, from which the nominal volume flow Q₀ can be determined by the initial determination), the degree of efficiency for each hydraulic axis can be determined and displayed (it lies between 0% and 100%). From this, a defect in the hydraulic system can be immediately concluded as soon as the efficiency falls below a specified minimum value (for example, below 95%).

If, for example, the degree of efficiency of the injection side is constantly at a high level, but the degree of efficiency of the closing side falls below the specified tolerance, it can be assumed that the pump system and the injection axis are in order, but that there is a defect (for example in the cylinder seals) in the closing system. In the opposite case, the defect would be in the injection axis.

If all efficiencies drop below a specified tolerance, it can be concluded that there is a defect in the pump system.

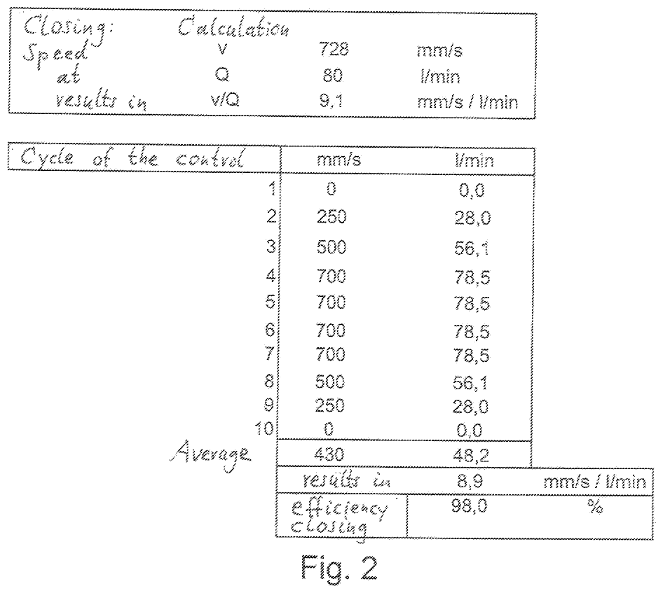

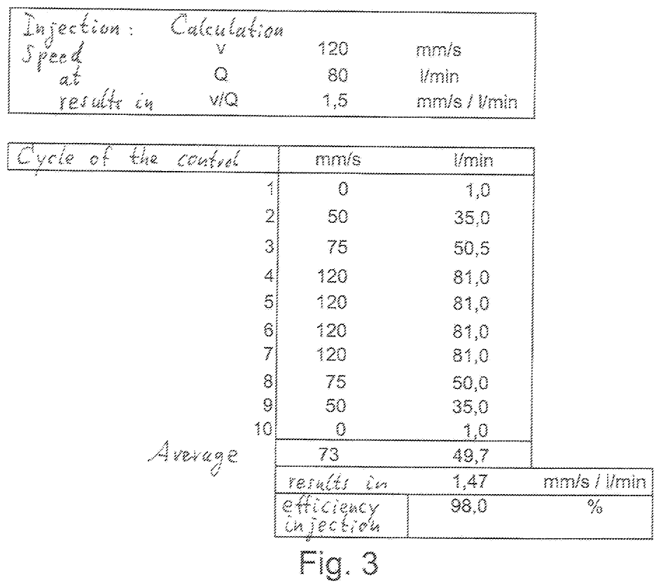

This is shown for an example in FIGS. 2 and 3:

In FIG. 2, for the closing movement of the mold of the injection molding machine, in the upper area, the initial determination (before the operation of the machine) of the parameters is shown (“Closing: Calculation”), while in the lower area (“Cycle of the control”) the acquisition of the data during the operation of the machine is listed. Then, at the very bottom of FIG. 2, the calculation of the degree of efficiency for this hydraulic axis is given.

FIG. 3 shows the analogous representation for the injection movement during an injection molding cycle.

At the top of the two Figures, it can first be seen that, given a detected speed v (in mm/s) of the hydraulic axis and a flow rate Q of the hydraulic pump, a ratio v/Q can be calculated (in mm/s per liter/min). This is the initial determination of the data before the actual operation of the machine. According to FIG. 2, at a speed of 728 mm/s and a flow rate of 80 liters/min, a quotient of the two quantities of 9.1 (mm/s/liters/min) is determined, which corresponds to the as-new condition of the hydraulic system, so to speak.

Subsequently, the respective speed (in mm/s) and the respective volume flow rate (in liters/min) are specified for a cycle with a total of 10 substeps; the substeps are then combined to form an average value. Again, the quotient of the average speed to the average volume flow rate (in FIG. 2: 430 mm/s divided by 48.2 liters/min) can then be calculated, resulting in an actual value during operation of the injection molding machine (in FIG. 2: of 8.9 (mm/s/liters/min).

To determine the degree of efficiency η, the quotient is formed.

In FIG. 2, this results in 8.9/9.1=98%=“Closing efficiency”.

The same procedure is followed for the injection movement of the machine as shown in FIG. 3. Here, too, the “injection efficiency” results as a quotient of 1.47/1.50 to 98%.

The result for the exemplary representation according to FIGS. 2 and 3 is therefore that efficiencies of 98% have been achieved for both the closing axis 2 and the injection axis 3, so that it can be concluded that both the piston-cylinder elements for closing and spraying are in order, which also applies to the hydraulic system as such.

If the degree of efficiency drops for one of the two hydraulic axes, it can be concluded that the piston-cylinder element of the relevant axis has become defective. If both efficiencies drop, however, there is a high probability that the hydraulic pump is damaged.

We claim:

1. A method for monitoring the hydraulic supply system of an at least partially hydraulically operating plastic processing machine, in particular an injection molding machine, wherein the machine has at least one hydraulically driven axis with at least one piston-cylinder element, wherein the hydraulic supply system comprises at least one driven hydraulic pump with which hydraulic oil is delivered and fed into the at least one piston-cylinder element in order to carry out a movement of the axis, wherein, in order to monitor the aging process or an internal leakage of the hydraulic pump or a hydraulic component of the hydraulic system, it comprises the following steps:
a) Prior operating the plastic processing machine:
a1) determination of the nominal flow rate of the hydraulic pump as a function of at least one operating parameter of the hydraulic pump and
a2) determination of the nominal displacement speed of the hydraulically driven axis when the piston-cylinder element is operated with a predetermined nominal flow rate;
b) During the operation of the plastic processing machine:
b1) When the hydraulically driven axis is operated: Measurement of the at least one operating parameter of the hydraulic pump as well as the actual displacement speed of the hydraulic axis;
b2) Comparison of the actual displacement speed or a variable directly related thereto with the nominal displacement speed or a variable directly related thereto, which result with the at least one operating parameter of the hydraulic pump measured according to step b1), and storage and/or output and/or display of the result of the comparison;
wherein an indication is output if the comparison according to step b2) shows that a deviation between the actual flow rate and the nominal flow rate or between the actual displacement velocity and the nominal displacement velocity has been determined which exceeds a predetermined tolerance.

2. The method according to claim 1, wherein step b2) comprises the substeps:
b2a) Determination of the actual flow rate required for the measured actual displacement speed;
b2b) Comparing the required actual flow rate with the nominal flow rate resulting from the at least one operating parameter of the hydraulic pump measured according to step b1), and storage and/or output and/or display of the result of the comparison.

3. The method according to claim 1, wherein it is carried out for a number of partial steps of the movement of the hydraulically driven axis.

4. The method according to claim 1, wherein the operating parameter is the rotational speed of the hydraulic pump.

5. The method according to claim 1, wherein the operating parameter is the swivel angle of the hydraulic pump.

6. The method according to claim 1, wherein it is carried out for several hydraulically driven axes.

7. The method according to claim 6, wherein it is performed for at least two of the following hydraulically driven axes: axis for closing a mold, axis for performing an injection operation of plastic melt into a mold, axis for moving an injection nozzle for plastic melt, axis for moving an ejector for a manufactured molded part.

8. The method according to claim 6, wherein the output of the result of the comparison according to step b2) is performed separately for several hydraulically driven axles.
